(19) United States
(12) Patent Application Publication
(10) Pub. No.: US 2015/0071470 A1
(43) Pub. Date: Mar. 12, 2015

(54) INTEGRATED CIRCUIT DIE INSIDE A FLEXIBLE CIRCUIT SUBSTRATE FOR A HEARING ASSISTANCE DEVICE

(71) Applicants: Douglas F Link, Plymouth, MN (US); Ay Vang, Eden Prairie, MN (US); John Dzarnoski, Eden Prairie, MN (US); Andy Lambert, Eden Prairie, MN (US); Dale Splettstoeszer, Waconia, MN (US); Susie Krzmarzick, Eden Prairie, MN (US); David Prchal, Hopkins, MN (US); Kexia Sun, Eden Prairie, MN (US); Yangjun Xing, Eden Prairie, MN (US)

(72) Inventors: Douglas F Link, Plymouth, MN (US); Ay Vang, Eden Prairie, MN (US); John Dzarnoski, Eden Prairie, MN (US); Andy Lambert, Eden Prairie, MN (US); Dale Splettstoeszer, Waconia, MN (US); Susie Krzmarzick, Eden Prairie, MN (US); David Prchal, Hopkins, MN (US); Kexia Sun, Eden Prairie, MN (US); Yangjun Xing, Eden Prairie, MN (US)

(73) Assignee: Starkey Laboratories, Inc., Eden Prairie, MN (US)

(21) Appl. No.: 14/025,222

(22) Filed: Sep. 12, 2013

(51) Int. Cl. H04R 25/00

(52) U.S. Cl. CPC H04R 25/65; H04R 25/60
USPC 381/322; 29/594

(57) ABSTRACT

Disclosed herein, among other things, are systems and methods for improved circuit design for hearing assistance devices. One aspect of the present subject matter includes a hearing assistance device configured to compensate for hearing losses of a user. The hearing assistance device includes a flexible circuit substrate and an integrated circuit die embedded within the flexible circuit substrate. The integrated circuit die includes a digital signal processor (DSP) die, in an embodiment. In various embodiments, the DSP die includes a DSP configured to provide processing for the hearing assistance device.

### TECHNICAL FIELD

This document relates generally to hearing assistance systems and more particularly to methods and apparatus for an integrated circuit die inside a flexible circuit substrate for a hearing assistance device.

### BACKGROUND

Modern hearing assistance devices, such as hearing aids, are electronic instruments worn in or around the ear that compensate for hearing losses of hearing-impaired people by specially amplifying sound. Hearing aids typically include a housing or shell with internal components such as a signal processor, a microphone and a receiver housed in a receiver case. The housing or shell of a hearing assistance device has a size limitation based on the application. Specifically, devices that include an in-the-ear portion have housings that are constrained by the geometry of the inner ear of the wearer.

Accordingly, there is a need in the art for improved systems and methods for efficient circuit design to reduce size of a hearing assistance device.

### SUMMARY

Disclosed herein, among other things, are systems and methods for improved circuit design for hearing assistance devices. One aspect of the present subject matter includes a hearing assistance device configured to compensate for hearing losses of a user. The hearing assistance device includes a flexible circuit substrate and an integrated circuit die embedded within the flexible circuit substrate. The integrated circuit die includes a digital signal processor (DSP) die, in an embodiment. Other types of dies, or multiple dies of the same or different type, can be embedded within the flexible circuit substrate without departing from the scope of the present subject matter.

One aspect of the present subject matter includes a hearing assistance device method. The method includes providing a flexible circuit substrate in a hearing assistance device housing, the flexible circuit substrate including an integrated circuit die inside the flexible circuit substrate. The integrated circuit die includes a DSP configured to provide processing for the hearing assistance device, according to various embodiments. Other types of dies, or multiple dies of the same or different type, can be embedded within the flexible circuit substrate without departing from the scope of the present subject matter.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1A illustrates a side view of a flexible circuit substrate for a hearing assistance device, according to various embodiments of the present subject matter.

FIGS. 1B-1C illustrate top and side views comparing circuits for hearing assistance devices and showing reduced size benefits, according to various embodiments of the present subject matter.

FIG. 2 illustrates a side view of a flexible circuit substrate for a hearing assistance device, the flexible circuit substrate including a die within the substrate, according to various embodiments of the present subject matter.

FIGS. 3A-3B illustrate a circuit module before and after folding, according to various embodiments of the present subject matter.

FIG. 4 illustrates a side view of a flexible circuit substrate for a hearing assistance device, the flexible circuit substrate including multiple dies within the substrate, according to various embodiments of the present subject matter.

FIGS. 5A-5C illustrate side views comparing circuits for hearing assistance devices and showing reduced package height benefits, according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present detailed description will discuss hearing assistance devices using the example of hearing aids. Hearing aids are only one type of hearing assistance device. Other hearing assistance devices include, but are not limited to, those in this document. It is understood that their use in the description is intended to demonstrate the present subject matter, but not in a limited or exclusive or exhaustive sense.

Hearing aids typically include a housing or shell with internal components such as a signal processor, a microphone and a receiver housed in a receiver case. The housing or shell of a hearing assistance device has a size limitation based on the application. Specifically, devices that include an in-the-ear portion have housings that are constrained by the geometry of the inner ear of the wearer. Smaller device components and circuit packages are needed.

Disclosed herein, among other things, are systems and methods for improved circuit design for hearing assistance devices. One aspect of the present subject matter includes a hearing assistance device configured to compensate for hearing losses of a user. The hearing assistance device includes a flexible circuit substrate and an integrated circuit die inside the flexible circuit substrate, or embedded therein. The integrated circuit die includes a digital signal processor (DSP) die, in an embodiment. In various embodiments, the DSP die includes a DSP configured to provide processing, such as audio and/or wireless communication processing, for the hearing assistance device.

Various current hearing aid microelectronic circuits use flip chip on flex (FCOF) technology, thick film technology, and surface-mount technology (SMT) on a rigid printed circuit board (PCB) for microelectronic packaging. Thick film technology is limited by three main factors: trace/space size, number of layers, and substrate thickness. Previously the smallest trace/space design rule is 5 mils (125 um), 3 layers, and a printed ceramic thickness of 17 mils. Thick film is generally considered to be lower cost compared to FCOF, but FCOF offers the advantage of miniaturization over thick film and the more traditional SMT on rigid PCB technology. While the more expensive FCOF circuits tend to be smaller than thick film circuits, they are also more susceptible to mechanical damage due to the exposed flip chip die. Methods to further protect the exposed die, such as backside die coating, require further size increases and higher cost.

Various embodiments of the present subject matter provides an integrated circuit (IC) die placed inside a flexible substrate to achieve an overall improvement compared to thick film while providing further miniaturization compared to FCOF. The IC die is a DSP die, in various embodiments. The present subject matter provides greater mechanical robustness than FCOF as the ICs are contained within the module, in various embodiments.

According to various embodiments, first the DSP die in wafer form is modified by addition of a redistribution layer (RDL) for electrical routing optimization. In one embodiment, the wafer is then thinned to ˜3.5 mils, much thinner than the 10-12 mil thick die used today for FCOF & thick film packaging. Other thicknesses can be used without departing from the scope of the present subject matter. The wafer is then diced into individual die which are then placed onto a high density (HDI) flexible circuit substrate, in various embodiments. Multiple layers of HDI flexible circuit substrate are then stacked around the die layer, according to various embodiments. Finally, the stacked panels of HDI flex are laminated in one step, and final back end processing is completed to finish the module, in various embodiments. The back end process can consist of SMT population, overmolding, solder pad formation, dicing, laser marking and testing depending on the specific application.

FCOF packaging is limited by the available footprint required to accommodate multiple dies and the fact that the die is exposed and susceptible to mechanical damage. The die thickness is 10 mils and requires addition of another 1-2 mils of protective coating films to prevent damage. Various embodiments of the present subject matter utilize a much thinner die (3.5 mils, in an embodiment) that is built into the flexible substrate simultaneously as part of the substrate fabrication process thereby reducing package height while also protecting the die. Other die thicknesses can be used without departing from the scope of the present subject matter.

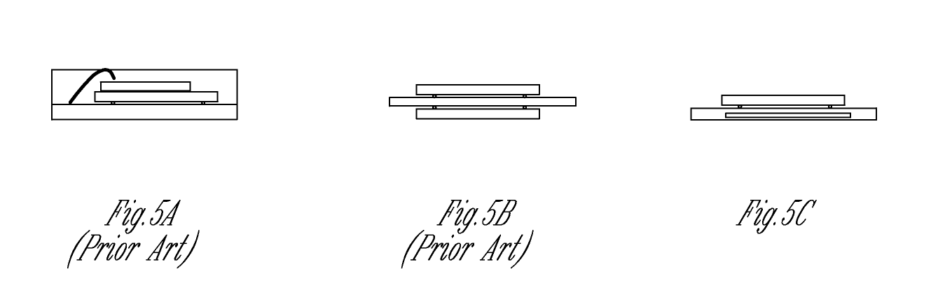

FIGS. 5A-5C illustrate side views comparing circuits for hearing assistance devices and showing reduced package height benefits, according to various embodiments of the present subject matter. Package height (in mils) are compared between thick film (FIG. 5A), FCOF (FIG. 5B), and the present subject matter (FIG. 5C), and illustrate the space savings using the present technology. The package embodiment shown in FIG. 5C contains a first chip including a DSP die and a second chip including one memory die.

In various embodiments, the present subject matter combines a very thin DSP integrated circuit placed inside a flexible substrate, a memory IC, such as an electrically erasable programmable read only memory (EEPROM) IC or ferroelectric random access memory (FRAM), and associated passive components into a single standalone DSP processor module capable of providing processing for a sophisticated digital hearing aid. In one embodiment, the present subject matter incorporates an 85 micron thin DSP IC with a redistribution layer (RDL). This IC is inserted within a multilayer flexible printed circuit (FPC) substrate during the FPC assembly process, in various embodiments. The flex substrate is then populated on one surface with a flip chip EEPROM IC (or other memory IC) and SMT components and over-molded for protection, in an embodiment. In various embodiments, the opposing surface of the flex substrate contains other SMT components and I/O pads for solder attachment of wires and/or flip chip attachment or ball grid array (BGA) attachment.

The present subject matter provides for hearing aid modules for all hearing assistance device products, such as: BTE, RIC, and custom ITE hearing instruments. Examples are shown in the accompanying figures. In various embodiments, the module includes at least one hearing aid DSP die that is thinned and placed inside a flexible circuit substrate. The substrate can include a material set including multiple HDI polyimide based flexible circuit layers, adhesive, and copper traces in various embodiments. On at least one surface are input/output (I/O) pads that can be BGA style, rectangular for solder attachment of wires, or other variations such as land grid array, in various embodiments.

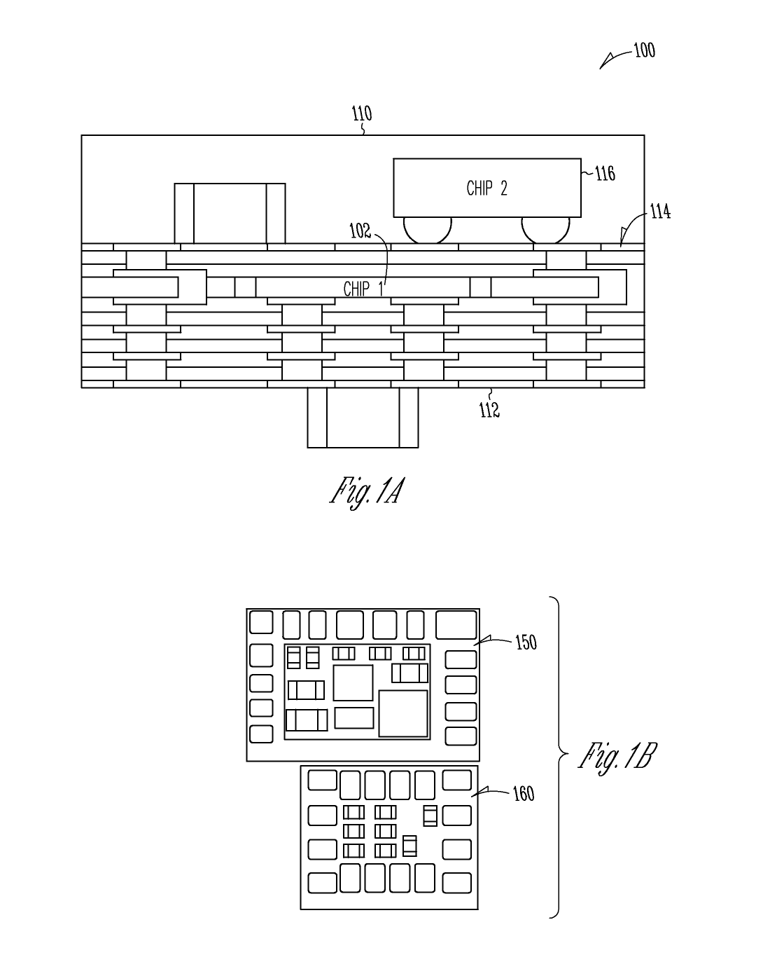

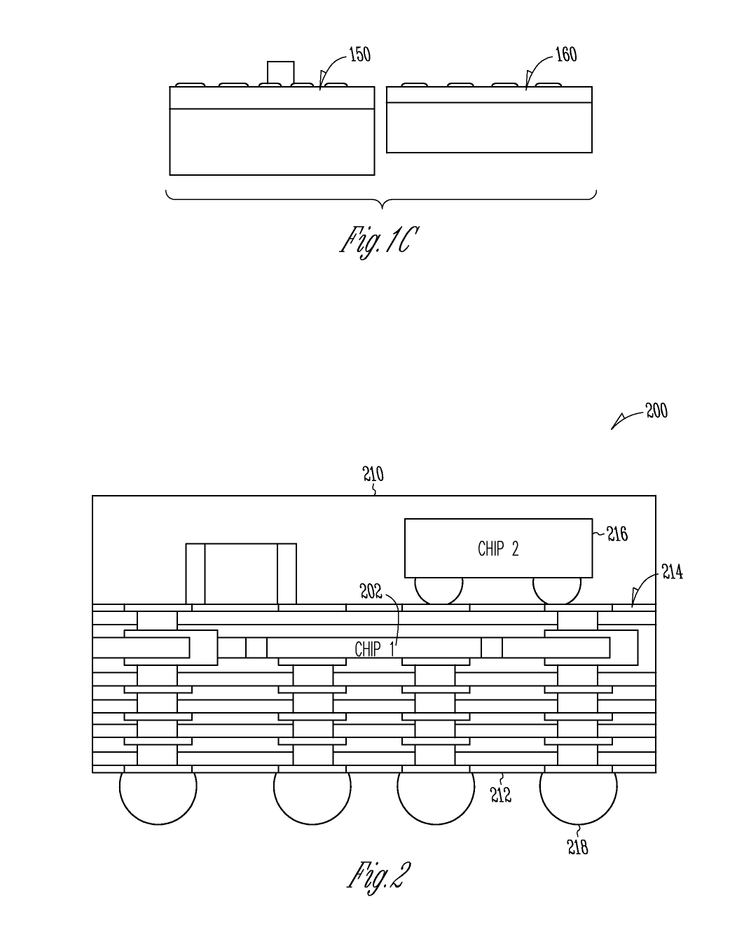

FIG. 1A illustrates a side view of a flexible circuit substrate 100 for a hearing assistance device, according to various embodiments of the present subject matter. The flexible circuit substrate 100 includes a first chip, or die 102 embedded within the substrate. In one embodiment, the first chip 102 is a DSP IC. One side 114 of the substrate includes a second chip 116 and additional passive components such as inductors (L) and capacitors (C), in various embodiments. In an embodiment, the second chip 116 is an EEPROM. In one embodiment, the first side 114 includes six passive components and an over-molding 110. The opposite side 112 includes solder pads and additional passive components, in various embodiments. In one embodiment, the pad side 112 includes eight passive components. In various embodiments, other die besides first chip can be fabricated within the substrate. The present subject matter provides a 60% smaller package and a significant savings compared to previous technology, in an embodiment. This approach uses a special RDL added at wafer level for the first chip, in various embodiments.

FIGS. 1B-1C illustrate top and side views comparing circuits for hearing assistance devices and showing reduced size benefits, according to various embodiments of the present subject matter. The module of the present subject matter 160, using a die embedded within a flexible circuit substrate, has smaller overall dimensions than the module of previous thick film technology 150. In one embodiment, the present module 160 has 60% smaller volume than the thick film module 150.

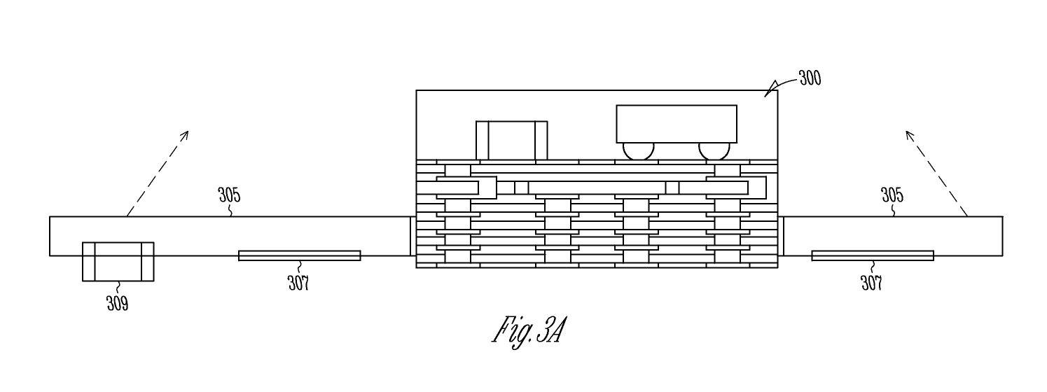

FIG. 2 illustrates a side view of a flexible circuit substrate 200 for a hearing assistance device, the flexible circuit substrate including a die, or first chip 202, embedded within the substrate, according to various embodiments of the present subject matter. One side 214 of the substrate includes a second chip 216 and additional passive components and an over-molding 210. In one embodiment, the second chip 216 includes an EEPROM. The opposite side 212 includes solder ball connections 218, in various embodiments. In various embodiments, the first chip 202 includes a DSP die 202 including a DSP wireless platform built upon a hearing aid digital processor. Other types of IC dies can be used without departing from the scope of the present subject matter. The DSP IC (first chip) is placed inside a 7 layer flex circuit substrate 200 populated with other components 216 on one surface and BGA style solder bumps 218 on the opposing surface, in an embodiment. In one embodiment, this package contains the hearing aid digital IC, a memory IC (such as an EEPROM IC), and associated passive components.

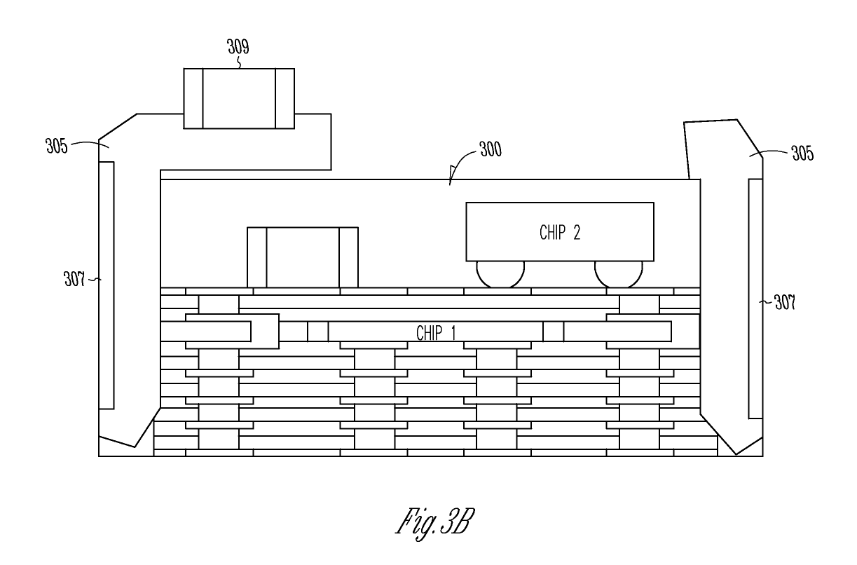

FIGS. 3A-3B illustrate a circuit module 300 before and after folding, according to various embodiments of the present subject matter. Flex circuit arms 305 extend from the flex circuit substrate and may serve two purposes: the arms can provide edge connection pads 307 or they can house additional electronic components 309, in various embodiments. In various embodiments, the module includes a wireless custom multichip module with a die embedded inside a flexible circuit substrate. Various types of dies, such as DSP dies or chips, can be used without departing from the scope of the present subject matter.

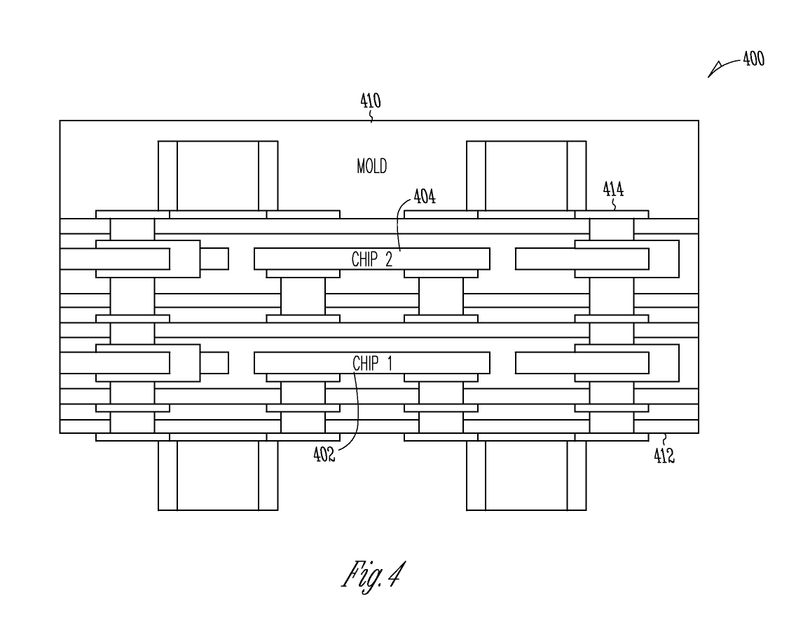

FIG. 4 illustrates a side view of a flexible circuit substrate 400 for a hearing assistance device, the flexible circuit substrate including multiple dies 402, 404 within the substrate, according to various embodiments of the present subject matter. One side 414 of the substrate includes additional passive components and an over-molding 410. The opposite side 412 includes additional passive components and solder pad connections, in various embodiments. In various embodiments, the module includes a non-wireless multichip DSP module for custom hearing aids that incorporates two dies embedded inside the flexible circuit substrate—the DSP IC 402 and the memory IC 404. Other types of chips or dies can be used without departing from the scope of the present subject matter. The internal die are stacked one atop the other or side-by-side, in various embodiments.

The present subject matter can be used for any type of hearing aid IC-based module (die), such as a power management IC module, a DSP IC module, a memory IC module, a radio IC module, or other feature module. In addition, the packaging solutions provided herein can be used for personal amplification devices and accessories or any related application that requires miniaturization. The present subject matter provides for the manufacture of smaller, higher density microelectronic devices and therefore smaller hearing aids. The present subject matter provides a lower cost than the thick film and FCOF packaging solutions, and reduces defects due to mechanical die manage that occur in some FCOF hearing aids today during the hearing aid assembly process.

The present subject matter provides for smaller hearing aids by inserting the hearing aid DSP die (and/or other dies or ICs) inside a flexible circuit substrate and SMT mounting other devices onto the flexible circuit substrate, in various embodiments. The present subject matter can also reduce microelectronic packages and offers mechanical robustness improvement over FCOF technology. In various embodiments, the present subject matter inserts a very thin (3.5 mils in an embodiment) hearing aid DSP die into a flexible circuit substrate as opposed to mounting the die onto the outer surface of a substrate. The present subject matter further miniaturizes microelectronic packages compared to FCOF and thick film technology. In various embodiments, the package of the present subject matter is more mechanically robust than FCOF technology, as no ICs are exposed.

It is understood that variations in combinations of components may be employed without departing from the scope of the present subject matter. Hearing assistance devices typically include an enclosure or housing, a microphone, hearing assistance device electronics including processing electronics, and a speaker or receiver. It is understood that in various embodiments the microphone is optional. It is understood that in various embodiments the receiver is optional. Antenna configurations may vary and may be included within an enclosure for the electronics or be external to an enclosure for the electronics. Thus, the examples set forth herein are intended to be demonstrative and not a limiting or exhaustive depiction of variations.

It is further understood that any hearing assistance device may be used without departing from the scope and the devices depicted in the figures are intended to demonstrate the subject matter, but not in a limited, exhaustive, or exclusive sense. It is also understood that the present subject matter can be used with a device designed for use in the right ear or the left ear or both ears of the user.

It is understood that the hearing aids referenced in this patent application include a processor. The processor may be a digital signal processor (DSP), microprocessor, microcontroller, other digital logic, or combinations thereof. The processing of signals referenced in this application can be performed using the processor. Processing may be done in the digital domain, the analog domain, or combinations thereof. Processing may be done using subband processing techniques. Processing may be done with frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, audio decoding, and certain types of filtering and processing. In various embodiments the processor is adapted to perform instructions stored in memory which may or may not be explicitly shown. Various types of memory may be used, including volatile and nonvolatile forms of memory. In various embodiments, instructions are performed by the processor to perform a number of signal processing tasks. In such embodiments, analog components are in communication with the processor to perform signal tasks, such as microphone reception, or receiver sound embodiments (i.e., in applications where such transducers are used). In various embodiments, different realizations of the block diagrams, circuits, and processes set forth herein may occur without departing from the scope of the present subject matter.

The present subject matter is demonstrated for hearing assistance devices, including hearing aids, including but not limited to, behind-the-ear (BTE), in-the-ear (ITE), in-the-canal (ITC), receiver-in-canal (RIC), invisible-in-canal (IIC) or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard, open fitted or occlusive fitted. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A hearing assistance device, comprising:
a flexible circuit substrate; and
one or more integrated circuit (IC) die embedded within the flexible circuit substrate, the one or more die configured to provide electronics for the hearing assistance device.

2. The device of claim 1, wherein the one or more die include a digital signal processor (DSP) die, the DSP die including a DSP configured to provide processing for the hearing assistance device.

3. The device of claim 1, wherein the one or more die include a memory IC die.

4. The device of claim 1, wherein the one or more die include a power management module.

5. The device of claim 1, wherein the one or more die include a radio module.

6. The device of claim 1, wherein the flexible circuit substrate includes multiple layers.

7. The device of claim 1, wherein the flexible circuit substrate includes additional surface mount components on one surface and solder pad connections on an opposing surface.

8. The device of claim 1, wherein the flexible circuit substrate includes flexible circuit arms extending from the flexible circuit substrate.

9. The device of claim 8, wherein the flexible circuit arms are configured to provide edge connection pads.

10. The device of claim 8, wherein the flexible circuit arms are configured to include additional electronic components.

11. The device of claim 2, further comprising a memory IC die inside the flexible circuit substrate.

12. The device of claim 11, wherein the DSP die is stacked on top of the memory IC die.

13. The device of claim 11, wherein the memory IC die is stacked on top of the DSP die.

14. The device of claim 11, wherein the memory IC die and the DSP die are side-by-side.

15. A method, comprising:
providing a flexible circuit substrate in a hearing assistance device housing, the flexible circuit substrate including one or more die embedded inside the flexible circuit substrate, wherein the one or more die are configured to provide electronics for the hearing assistance device.

16. The method of claim 15, wherein the one or more die include a DSP die configured to provide processing for the hearing assistance device.

17. The method of claim 16, further comprising a memory IC die inside the flexible circuit substrate.

18. The method of claim 15, wherein the hearing assistance device includes a hearing aid.

19. The method of claim 18, wherein the hearing aid includes an in-the-ear (ITE) hearing aid.

20. The method of claim 18, wherein the hearing aid includes a behind-the-ear (BTE) hearing aid.

21. The method of claim 18, wherein the hearing aid includes an in-the-canal (ITC) hearing aid.

22. The method of claim 18, wherein the hearing aid includes a receiver-in-canal (RIC) hearing aid.

23. The method of claim 18, wherein the hearing aid includes a completely-in-the-canal (CIC) hearing aid.

24. The method of claim 18, wherein the hearing aid includes a receiver-in-the-ear (RITE) hearing aid.

25. The method of claim 18, wherein the hearing aid includes an invisible-in-canal (IIC) hearing aid.
